(19) United States
(12) Patent Application Publication
(10) Pub. No.: US 2026/0181072 A1
(43) Pub. Date: Jun. 25, 2026

(54) SYSTEM AND METHOD FOR DEVICE MATCHING DURING A CUSTOMER SERVICE CALL

(71) Applicant: Capital One Services, LLC, McLean, VA (US)

(72) Inventors: Michael Mossoba, Arlington, VA (US); Wayne Lutz, Glen Allen, VA (US); Edward Abdullah, Bluffton, SC (US); Adrian Cruz, McLean, VA (US); Bertrand Prenat, McLean, VA (US); David Ross, Richmond, VA (US)

(73) Assignee: Capital One Services, LLC, McLean, VA (US)

(21) Appl. No.: 18/988,061

(22) Filed: Dec. 19, 2024

(51) Int. Cl. H04M 3/38

(52) U.S. Cl. CPC H04M 3/382; H04M 2203/6081

(57) ABSTRACT

Embodiments are directed to systems and techniques to perform device matching during a customer service call. In some examples, the techniques provided herein include receiving, at a call center system, a communication from a device associated with a user account. The method further includes, in response to receiving the communication, sending a message to the device associated with the user account, the message including a link for a user to interact with on a user interface of the device, wherein interaction with the link by the user causes initiation of an application on the device for receiving encrypted data from a contactless card associated with the user account. The method further includes receiving, by the call center system, from an authentication server, an authorization message indicating whether the user account is authorized to maintain the communication based on an evaluation of the encrypted data by the authentication server.

### FIELD OF INVENTION

The present disclosure generally relates to call centers. More particularly, the present disclosure relates to authenticating a user or caller in the context of a customer service call.

### BACKGROUND

Call centers are frequently used by enterprises and other organizations to manage large volumes of user calls, such as service calls. When a user calls into the call center, there is generally no easy way to verify that the user is permitted to engage with the call center. For example, the user may be required to have a certain membership or certain plan to connect with the call center. Using caller ID is not sufficient because phone numbers can be easily falsified, or “spoofed.” Additionally, in some cases, those intending to commit fraud can trick users by calling customer service on the user's behalf while also impersonating customer service on the ir victim. This enables those who wish to commit fraud to obtain sensitive information to overcome authentication protocols.

Accordingly, there is a need to provide businesses and users with an appropriate solution that overcomes current deficiencies to provide data security, authentication, and verification for users calling into call centers.

### BRIEF SUMMARY

One general aspect of the present disclosure includes a method for device matching during a customer service call. In some embodiments, the method includes receiving, at a call center system, a communication from a device associated with a user account; in response to receiving the communication, sending, by the call center system, a message to the device associated with the user account, the message including a link for a user to interact with on a user interface of the device, where interaction with the link by the user causes initiation of an application on the device for receiving encrypted data from a contactless card associated with the user account; and receiving, by the call center system from an authentication server, an authorization message indicating whether the user account is authorized to maintain the communication based on an evaluation by the authentication server of the encrypted data.

Another general aspect includes an apparatus for device matching during a customer service call. In some embodiments, the apparatus includes a memory to store instructions thereon. In some embodiments, the apparatus also includes a user interface to receive input and display output to a user of the apparatus. In some embodiments, the apparatus also includes a processing circuit to execute the instructions, which when executed by the processing circuit, cause the apparatus to receive, from a call center system, a message including a link for the user of the apparatus to interact with via the user interface. In some embodiments, in response to the user interacting with the link, the processing circuit is caused to initiate operation of an application of the apparatus, the application to receive encrypted data from a contactless card associated with a user account of the user. In some embodiments, the processing circuit is further caused to receive the encrypted data from the contactless card and send the encrypted data to an authentication server to verify an identity of the user account.

Another general aspect includes a non-transitory computer-readable storage medium having instructions stored thereon for device matching during a customer service call. When the instructions are executed by a processing circuit of a voice server, the execution of the instructions causes the voice server to receive a communication from a device associated with a user account. In some embodiments, in response to receiving the communication, the processing circuit is caused to send a message to the device associated with the user account, the message including a digital reference for a user to interact with on a user interface of the device, where interaction with the digital reference by the user causes initiation of an application on the device for receiving encrypted data from a contactless card associated with the user account. In some embodiments, the processing circuit is caused to receive, from an authentication server, an authorization message indicating whether the user account is authorized to maintain the communication based on an evaluation by the authentication server of the encrypted data.

Non-transitory computer program products (i.e., physically embodied computer program products) are also described that store instructions, which, when executed by one or more data processors (i.e., processing circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

FIG. 1 is a network diagram illustrating an example system in accordance with one embodiment.

FIG. 2 is a block diagram illustrating an example user device in accordance with one embodiment.

FIG. 3 is a block diagram illustrating an example voice server in accordance with one embodiment.

FIG. 4 illustrates an example contactless card in accordance with one embodiment.

FIG. 5 illustrates an example transaction card component in accordance with one embodiment.

FIG. 6 is a flow diagram illustrating operations of an example method in accordance with one embodiment.

FIG. 7 illustrates a sequence flow in accordance with one embodiment.

FIG. 8 illustrates an example of a system configured to operate in accordance with one embodiment.

FIG. 9A illustrates an example flow diagram in accordance with one embodiment.

FIG. 9B illustrates an example flow diagram in accordance with one embodiment.

FIG. 9C illustrates an example flow diagram in accordance with one embodiment.

FIG. 10 illustrates an example message format diagram in accordance with one embodiment.

FIG. 11 is a diagram of a key system in accordance with one embodiment.

FIG. 12 illustrates a routine in accordance with one embodiment.

FIG. 13 illustrates an example network diagram in accordance with one embodiment.

FIG. 14 illustrates an example flow diagram in accordance with one embodiment.

### DETAILED DESCRIPTION

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identity, perform a payment, launch applications, log into applications, autofill a form or field, navigate to a specified web location or app on a device, unlock a door, initiate a contactless card, verify themselves, and so forth. In some examples, the user can verify their identity for the purposes of gaining access to call center services, as discussed herein.

Described herein is system and method for device matching during a customer service call. In some cases, the user (e.g., customer) will call into the customer service line, operated by a call server, and, after the call is generated, but before the call is allowed to be forwarded to the customer service agent, the customer's identity is validated. Namely, the customer's possession of both their contactless card and their mobile device is validated or authenticated. For example, the user can provide identifying information about themselves before the call is permitted to proceed. The information could include their phone number (e.g., gathered by the voice server using caller ID), their name, email address, account number, social security number, etc. The call server of the customer service organization can then provide a link (e.g., URL, QR code, etc.) to the customer phone number or email address on record for the user (based on the information they provide to the call server). Alternatively the link can be sent to the number from caller ID.

Once the user device receives the link, the user can interact with (e.g., click, select, etc.) the link and that triggers their mobile device to prompt the user to tap their card to the mobile device. The card is then tapped and encrypted data is sent from the contactless card to the mobile device via NFC or BlueTooth®, or other suitable communication protocol. The encrypted data is then forwarded to an authentication server via a switching network and validated by the authentication server. The authentication server then sends a message to the call server that the card is authenticated. At that point, the voice server is confirmation that the user calling into the customer service system is in possession of both the contactless card and mobile device on file, thereby authenticating the identity of the user. Once the user is authenticated, the customer service call is permitted to continue.

The systems discussed herein may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system or routing system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

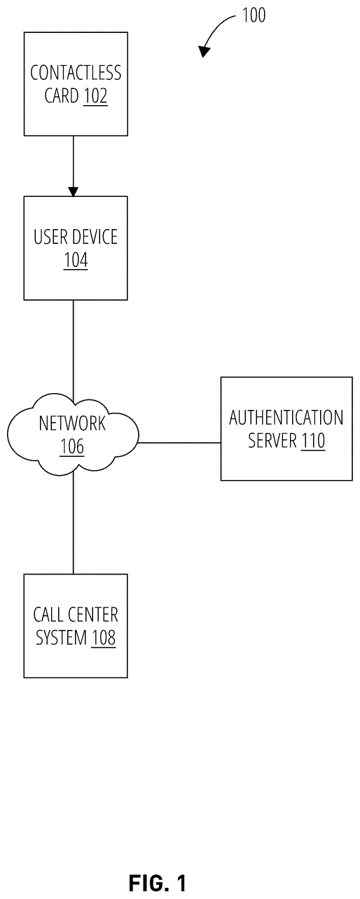

FIG. 1 is a network diagram illustrating an example system 100 according to some embodiments of the present disclosure. In some embodiments, the system 100 includes a contactless card 102, a user device 104, a network 106, a call center system 108, and an authentication server 110.

As described above, the system 100 can be used, for example, to verify an identity of a caller attempting to access the call center system 108, for example from user device 104. The verification or authentication step is to occur after the support call is generated by the user, but before the user or caller is permitted to access a support system associated with the call center system 108. For example, after the user has generated their call, but before the user is able to access technical support for their product, or some other support system, the user that is calling in will be verified or authenticated. In some embodiments, the system 100 will verify that the user is authorized to access the call center system 108. The system 100 may also verify an identity of the user. For example, a malicious actor may spoof an authorized user's number and attempt to gain access to the call center system 108. The system 100 would prevent that from occurring as discussed herein.

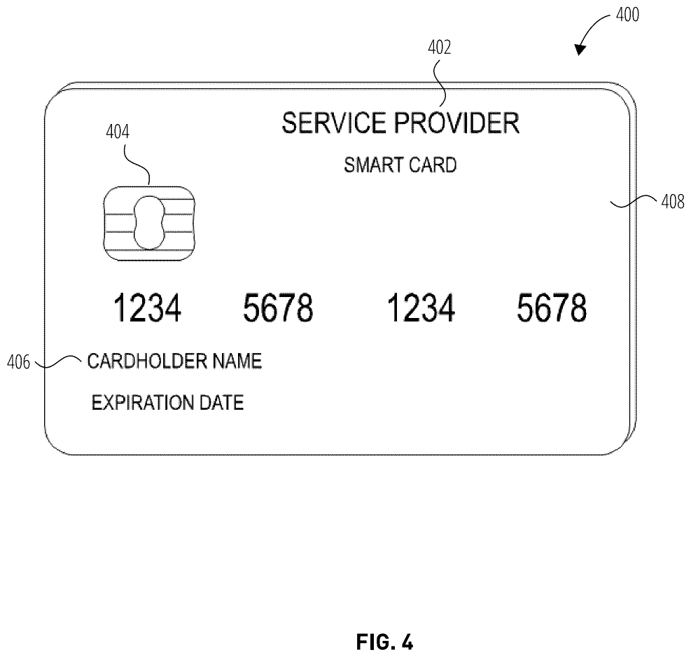

In some embodiments, the contactless card 102 can include any suitable contactless card such as the contactless card 400 described below in FIG. 4. In some embodiments, the user device 104 can include any suitable computing device such as a smart phone, tablet, tablet computer, mobile device, mobile phone, cell phone, iPhone®, smart watch, wearable device, personal computer (PC), voice over IP (VOIP) phone, or any other suitable computing device. The user device 104 is configured to initiate a call with the call center system 108 to start a support call with the call center system 108 over the network 106.

In some embodiments, the network 106 can include any suitable network such as a local area network (LAN), a wide area network (WAN), the Internet, a mobile communications network (e.g., 3G, 4G, LTE, 5G, 6G, or any other suitable mobile communications network), a wireless LAN (WLAN), voice over IP (VOIP) network, any combination thereof, or any other suitable network. The network 106 provides a communication path between the user device 104, the call center system 108, and the authentication server 110. That is, the user device 104, call center system 108, and authentication server 110 can each communicate over the network 106.

In some embodiments, the call center system 108 is a server managed by a call center. For example, the call center system 108 may include a voice server, a cloud-based server, call center software, and/or any other system equipment (e.g., computing equipment) or software for maintaining and managing a call center. In some embodiments the authentication server 110 is a server configured for decrypting encrypted messages and data to determine whether a user device that sent the encrypted data is authorized to access the call center system 108. For example, the authentication server 110 determines whether an authenticated user is permitted to call the call center system 108 and access services of the call center system 108.

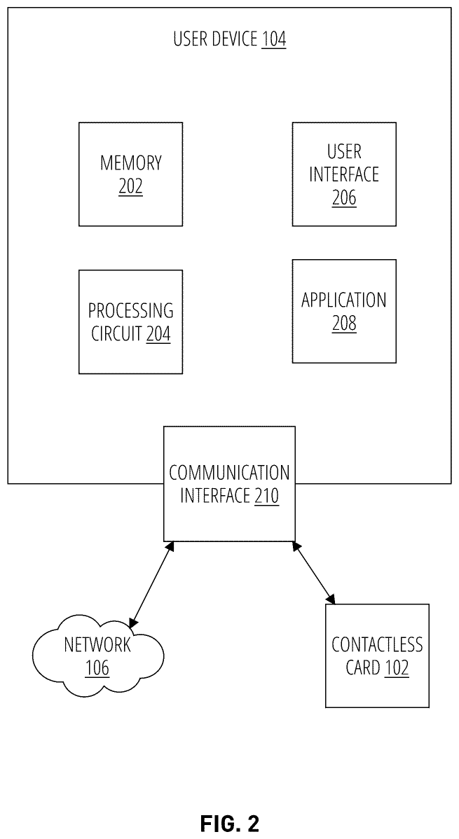

FIG. 2 is a block diagram illustrating an example user device 104 in accordance with some embodiments of the present disclosure. As described above, in some embodiments, the user device 104 is a smart phone or other mobile device capable of accessing the Internet or other network 106. In some embodiments, the user device 104 includes a memory 202 to store instructions thereon, a user interface 206 to receive input and display output to a user of the user device 104, and a processing circuit 204 to execute the instructions.

In some embodiments, the processing circuit 204 can be any suitable processing circuit such as a processor, central processing unit (CPU), microprocessor, mobile processor (e.g., processor for a mobile device), application specific integrated circuit (ASIC), or any other suitable processing circuit 204. In some embodiments, the user interface 206 includes a touchscreen (e.g., a mobile phone or mobile device screen), one or more buttons, one or more switches, one or more actuators, or any other suitable user interface 206. In some embodiments, a user of the user device 104 can manipulate or interact with the user interface 206, including selecting displayed data (e.g., on a touchscreen), buttons, or icons, via a graphical user interface (GUI) on the user interface 206.

In some embodiments, the processing circuit 204 is configured to execute the instructions in the memory 202, which causes the processing circuit 204 to perform various operations. For example, in some embodiments, in response to executing the instructions, the processing circuit 204 is configured to receive, from the call center system 108, via a communication interface 210 and the network 106, a message including a link for a user of the user device 104 to interact with via the user interface 206. In some embodiments, the link is a uniform resource locator (URL), a quick response code (QR code), a tinyURL, an image link, a JavaScript link, a HyperText Markup Language (HTML) link, or any other suitable link that is a unique identifier used to locate a resource on the Internet, activate, initiate, or execute an application or feature on the user device 104, or any other suitable link. For example, the link can include a digital reference to a website or a software application, and interaction (e.g., selecting the link on a touchscreen of the user interface 206) with the link includes the user interface 206 being configured to receive input from the user indicating selection of the link.

In some embodiments, the processing circuit 204 is configured to receive the message, including the link, in response to the user device 104 initiating a communication with the call center system 108. That is, the link is sent from the call center system 108 to the user device 104 in response to the user device 104 starting a communication (e.g., a phone call or text message) from the user device 104 to the call center system 108. In some embodiments, the link or message from the call center system 108 is sent prior to the communication from the user device 104 to the call center system 108 being permitted to continue to systems beyond an initialization process of the call center system 108. For example, before the user of the user device 104 is transferred to technical support, customer service, or any other further features of the call center system 108.

In some embodiments, the link is provided on the user interface 206 for the user to inspect and interact with. For example, the user may select the link with their finger or a button, the user may copy the link to paste into a browser or other application, or any other suitable interaction. In response to the user interacting with the link, the processing circuit 204 of the user device 104 is configured to initiate operation of a web browser or a software application 208 of the user device 104, the web browser directed to a website, or the software application 208 opened, based on contents of the link. In some embodiments, the application 208 is configured to cause the user device 104 to receive encrypted data from a contactless card 102 associated with a user account of the user. The website may also receive encrypted data from the contactless card 102 associated with the user account of the user.

For example, in some embodiments, the application 208 causes the user device 104 to receive the encrypted data from the contactless card 102 via the communication interface 210. In some embodiments, the communication interface 210 is a wireless communication interface that allows the user device 104 to receive and send data to and from the network 106 and the contactless card 102. The communication interface 210 can operate using various forms of communication. For example, in some embodiments, the communication interface 210 includes a wireless interface capable of communicating data via wireless Ethernet, a mobile communications protocol (e.g., 3G, 4G, LTE, 5G, 6G, etc.), BlueTooth®, near field communication (NFC), radio-frequency identification (RFID), wireles fidelity (Wi-Fi), or other suitable communication protocol. In some embodiments, the user device 104 communicates with the network 106 via the communication interface 210 using wireless Ethernet, WiFi, or a wireless communications protocol. In some other embodiments, the user device 104 communicates with the contactless card 102 via the communication interface 210 using BlueTooth®, NFC, RFID, or WiFi.

In some embodiments, the processing circuit 204 of the user device 104 is configured to receive the encrypted data from the contactless card 102 (e.g., via an NFC exchange whereby the user taps the contactless card 102 to the user device 104 near the communication interface 210 and the encrypted data is communicated to the user device 104 via NFC exchange). For example, in some embodiments, the processing circuit 204 is further configured to initiate, by the website or the software application 208, a receive function of the user device 104, whereby the receive function causes the user device 104 to receive, via the communication interface 210 of the user device 104, the encrypted data from the contactless card 102 when the contactless card 102 is brought within a proximity of the user device 104.

In some embodiments, after the user device 104 has received the encrypted data from the contactless card 102, the processing circuit 204 is configured to send, via the communication interface 210 and the network 106, the encrypted data to an authentication server, such as authentication server 110, to verify an identity of the user account. The encrypted data is used by the contactless card 102 to verify an authenticity of the user calling from the user device 104. As part of a security procedure with the call center system 108, the call center system 108 attempts to verify an identity of the user account associated with the user device 104 before the user account is permitted to receive phone support or other technical support provided by the call center system 108.

In some embodiments, the processing circuit 204 is further configured to receive, as part of the message from the call center system 108, a session identifier (session ID) to associate the communication from the user device 104 with the encrypted data from the contactless card 102. For example, the session ID can be any unique identifier to associate the pending communication made by the user device 104 with encrypted data from the contactless card 102. In some embodiments, in response to the user device 104 receiving the encrypted data from the contactless card 102, it will send the encrypted data with the session ID to the authentication server 110 so that the authentication server 110 can authorize the encrypted data and associate it with the session ID. As such, when the authentication server 110 informs the call center system 108 that the user associated with the user device 104 is authorized to access services of the call center system 108, the call center system 108 will know which call to permit to proceed. The call center system 108 will permit the call associated with the session ID.

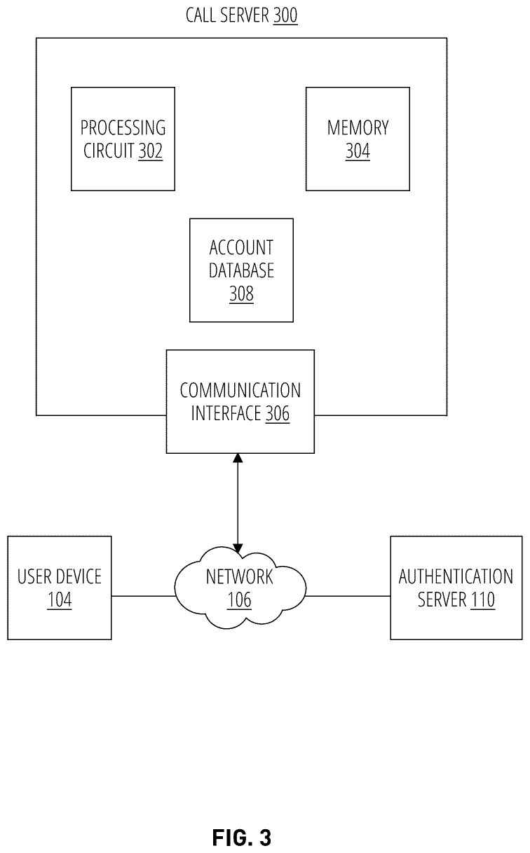

FIG. 3 is a block diagram of an example call server 300 that, for example, could manage voice calls received at the call center system 108 of FIG. 1 and FIG. 2. The call server 300 can include any suitable server capable of handling incoming call data as well as managing communications between the call server 300 and the user device 104 and authentication server 110. The call server 300 is part of the call center system 108 described above.

Similar to the user device 104 described above in FIG. 2, the call server 300 includes a processing circuit 302 and a memory 304 having executable instructions stored thereon. In response to the processing circuit 302 executing the instructions, the processing circuit 302 is configured to perform various operations described herein. The call server 300 further includes a communication interface 306 similar to the communication interface 210 of the user device 104. In some embodiments, the communication interface 306 is a wired or wireless communication interface 306. For example, in some embodiments, the communication interface 306 includes a wired Ethernet interface, a wireless Ethernet interface, a LAN interface, a WLAN interface, or any other suitable communication interface. The communication interface 306 can communicate over the network 106 via Ethernet, Wi-Fi, or a wireless communications protocol (e.g., 3G, 4G, LTE, 5G, 6G, etc.).

In some embodiments, the call server 300 is configured to receive a communication from a device associated with a user account, such as the user device 104. The communication can include a voice call, a video call, a chat message, a text message, an email, or any other suitable communication. Although the call server 300 can be embodied as a server handling voice data, the call server 300 could additionally, or alternatively, be configured to manage textual communications as described above.

In some embodiments, the communication from the user device 104 can include the initialization of a phone call, such as when a user dials the phone number associated with the call server 300. Alternatively, the communication can include the user initiating a text or chat exchange with the call server 300. In such embodiments, in response to receiving the communication, the call server 300 is configured to send a message to the user device 104 associated with the user account attempting to access services provided by the call server 300.

In some embodiments, as described above, the message includes a link for a user to interact with on a user interface of the user device 104. In some embodiments, the message is transmitted to a phone number or email address associated with the user account of the user device 104. The phone number or email address can be gathered or determined from an account database entry in an account database 308, the account database entry being associated with the user account associated with the user device 104. The account database 308 can be housed on the call server 300 or any other suitable server in communication with the call server 300. In some embodiments, the email address or phone number is associated with the user device 104 associated with the user account.

Interaction with the link by the user causes initiation of an application on the user device 104 for receiving encrypted data from a contactless card, such as contactless card 102 from FIG. 1 and FIG. 2 associated with the user account.

In some embodiments, the processing circuit 302 is further configured to receive, from the authentication server 110, an authorization message indicating whether the user account is authorized to maintain the communication based on an evaluation of the encrypted data by the authentication server 110. In response to the call server 300 receiving the authorization message that indicates that the user account is permitted to maintain the communication, the call server 300 is configured to maintain the communication with the user device 104 associated with the user account.

That is, the call made by the user, using the user device 104 is permitted to continue and the user can access the support systems of the call center system 108. For example, in response to the authorization message indicating that the user account is authorized, the call center system 108 can connect the user device 104, and therefore the user, with a support person on another line associated with the call center system 108. In some other embodiments, in response to the authorization message indicating that the user account is authorized, the call center system 108 connects the user device 104 with an automated system or other system the user wishes to connect with (e.g., based on the phone number they called).

In some embodiments, the communication is a textual based communication and the call server 300 permits the user to access a chat room or chat with a support person or automated chat system.

In some embodiments, in response to the call server 300 receiving the authorization message that indicates that the user account is not permitted to maintain the communication, the call server 300 is configured to terminate the communication with the user device 104. That is, the call server 300 is configured to terminate the call with the user device 104, or terminate a text communication with the user or the like. For example, while the user is sent the link to interact with, the call or chat between the user device 104 and the call server 300 is on hold until after the authorization message is sent to the call server 300 from the authentication server 110. If the authorization message from the authentication server 110 indicates that the user account is not authorized, then the call is dropped by the call server 300 or the chat is terminated.

In some embodiments, the call server 300 is configured to send the message to the user device 104, which includes the call server 300 assigning a session identifier (session ID) to the communication from the user device 104. This is similar to the session ID described above in FIG. 1. The session ID is assigned to the call or text message as it is received by the call server 300, and the session ID is sent with the link to the user device 104, and then the user device 104 again sends the session ID with the encrypted data from the contactless card 102 to the authentication server 110. The authentication server 110 then sends the authorization message to the call server 300 indicating whether the user account is authorized, and the authorization message includes the session ID so that call server 300 will know which call or chat instance is being authorized or denied. The session ID is included in the message (e.g., that includes the link) from the call server 300 to the user device 104 to associate the link in the message with the communication. In some embodiments, the call server 300 is configured to receive the authorization message from the authentication server 110 including the call server 300 configured to receive the session ID with the authorization message to associate the authorization message with the communication from the user device 104.

In some embodiments, the call server 300 receives a plurality of communications simultaneously, or substantially simultaneously. In such embodiments, the call server 300 is configured to assign a corresponding unique session ID to each of the plurality of communications. Additionally, the call server 300 is configured to receive, from the authentication server 110, a corresponding authorization message for at least some of the plurality of communications. In response to receiving the corresponding authorization message for at least some of the plurality of communications, the call server 300 is configured to determine which of the plurality of communications are authorized based on each session ID included in the corresponding authorization messages received. Once the call server 300 determines which of the communications are authorized, the call server 300 is configured to maintain (e.g., allow the calls or chats to continue) the communications of those user accounts that were authorized, and terminate the communications of those user accounts that were not authorized.

FIG. 4 illustrates an example configuration of a contactless card 400. The contactless card 400 is representative of one possible embodiment of the contactless card 102 from FIG. 1 and FIG. 2. In some embodiments, the contactless card 400 can include a contactless card, a payment card, such as a credit card, debit card, or gift card, issued by a service provider as displayed as service provider indicia 402 on the front or back of the contactless card 400. In some examples, the contactless card 400 is not related to a payment card, and may include, without limitation, an identification card. In some examples, the transaction card may include a dual interface contactless payment card, a rewards card, and so forth. The contactless card 400 may include a substrate 408, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 400 may have physical characteristics compliant with the ID-1 format of the ISO/IEC 7816 standard, and the transaction card may otherwise be compliant with the ISO/IEC 14443 standard. However, it is understood that the contactless card 400, according to the present disclosure, may have different characteristics, and the present disclosure does not require a transaction card to be implemented in a payment card.

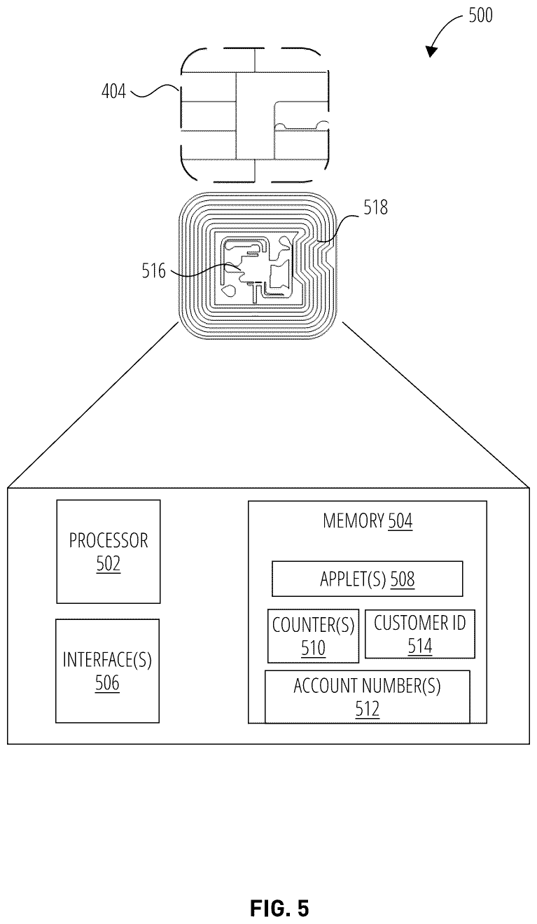

The contactless card 400 may also include identification information 406 displayed on the card's front and/or back, and a contact pad 404. The contact pad 404 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 400 may also include processing circuitry, antenna and other components as will be further discussed in FIG. 5. These components may be located behind the contact pad 404 or elsewhere on the substrate 408, e.g. within a different layer of the substrate 408, and may electrically and physically coupled with the contact pad 404. The contactless card 400 may also include a magnetic strip or tape, which may be located on the back of the card (not shown in FIG. 4). The contactless card 400 may also include a Near-Field Communication (NFC) device coupled with an antenna capable of communicating via the NFC protocol. Embodiments are not limited in this manner.

FIG. 5 illustrates an example transaction card component 500 according to some embodiments of the present disclosure. As illustrated in FIG. 5, the contact pad 404 of contactless card 400 may include processing circuitry 516 for storing, processing, and communicating information, including a processor 502, a memory 504, and one or more interface(s) 506. It is understood that the processing circuitry 516 may contain additional components, including processors, memories, error, and parity/CRC checkers, data encoders, anticollision algorithms, controllers, command decoders, security primitives, and tamper-proofing hardware, as necessary to perform the functions described herein.

The memory 504 may be a read-only memory, write-once read-multiple memory or read/write memory, e.g., RAM, ROM, and EEPROM, and the contactless card 400 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programmed many times after leaving the factory. A read/write memory may also be read many times after leaving the factory. In some instances, the memory 504 may be encrypted using an encryption algorithm executed by the processor 502 to encrypt data.

The memory 504 may be configured to store one or more applet(s) 508, one or more counter(s) 510, a customer identifier 514, and the account number(s) 512, which may be virtual account numbers. The one or more applet(s) 508 may include one or more software applications configured to execute on one or more contactless cards, such as a Java® Card applet. However, it is understood that applet(s) 508 are not limited to Java Card applets, and instead may be any software application operable on contactless cards or other devices having limited memory. The one or more counter(s) 510 may comprise a numeric counter sufficient to store an integer. The customer identifier 514 may comprise a unique alphanumeric identifier assigned to a user of the contactless card 400, and the identifier may distinguish the user of the contactless card from other contactless card users. In some examples, the customer identifier 514 may identify both a customer and an account assigned to that customer and may further identify the contactless card 400 associated with the customer's account. As stated, the account number(s) 512 may include thousands of one-time use virtual account numbers associated with the contactless card 400. An applet(s) 508 of the contactless card 400 may be configured to manage the account number(s) 512 (e.g., to select an account number(s) 512, mark the selected account number(s) 512 as used, and transmit the account number(s) 512 to a mobile device for auto-filling by an auto-filling service.

The processor 502 and memory elements of the foregoing exemplary embodiments are described with reference to the contact pad 404, but the present disclosure is not limited thereto. It is understood that these elements may be implemented outside of the contact pad 404 or entirely separate from it or as further elements in addition to processor 502 and memory 504 elements located within the contact pad 404.

In some examples, the contactless card 400 may comprise one or more antenna(s) 518. The one or more antenna(s) 518 may be placed within the contactless card 400 and around the processing circuitry 516 of the contact pad 404. For example, the one or more antenna(s) 518 may be integral with the processing circuitry 516 and the one or more antenna(s) 518 may be used with an external booster coil. As another example, the one or more antenna(s) 518 may be external to the contact pad 404 and the processing circuitry 516.

In an embodiment, the coil of contactless card 400 may act as the secondary of an air core transformer. The terminal may communicate with the contactless card 400 by cutting power or amplitude modulation. The contactless card 400 may infer the data transmitted from the terminal using the gaps in the contactless card's power connection, which may be functionally maintained through one or more capacitors. The contactless card 400 may communicate back by switching a load on the contactless card's coil or load modulation. Load modulation may be detected in the terminal's coil through interference. More generally, using the antenna(s) 518, processor 502, and/or the memory 504, the contactless card 400 provides a communications interface to communicate via NFC, Bluetooth, and/or Wi-Fi communications.

The contactless card 400 may be built on a software platform operable on smart cards or other devices with limited memory, such as JavaCard. One or more applications or applets may be securely executed. Applet(s) 508 may be added to the contactless card 400 to provide a one-time password (OTP) for multifactor authentication (MFA) in various mobile application-based use cases. Applet(s) 508 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag. In embodiments, one or more applet(s) 508 may be installed at the time of manufacturing, personalization, and/or after the user has possession of the contactless card 400.

One example of an NDEF OTP is an NDEF short-record layout (SR=1). In such an example, one or more applet(s) 508 may be configured to encode the OTP as an NDEF type 4 well known type text tag. In some examples, NDEF messages may comprise one or more records. The applet(s) 508 may be configured to add one or more static tag records in addition to the OTP record.

In some examples, the one or more applet(s) 508 may be configured to emulate an RFID tag. The RFID tag may include one or more polymorphic tags. In some examples, each time the tag is read, different cryptographic data is presented that may indicate the authenticity of the contactless card. Based on the one or more applet(s) 508, an NFC read of the tag may be processed, the data may be transmitted to a server, such as a server of a banking system, and the data may be validated at the server.

In some examples, the contactless card 400 and server may include certain data such that the card may be properly identified. The contactless card 400 may include one or more unique identifiers (not pictured). Each time a read operation takes place, the counter(s) 510 may be configured to increment. In some examples, each time data from the contactless card 400 is read (e.g., by a mobile device), the counter(s) 510 is transmitted to the server for validation and determines whether the counter(s) 510 are equal (as part of the validation) to a counter of the server.

The one or more counter(s) 510 may be configured to prevent a replay attack. For example, if a cryptogram or encrypted data has been obtained and replayed, that cryptogram or encrypted data is immediately rejected if the counter(s) 510 has been read or used or otherwise passed over. If the counter(s) 510 has not been used, it may be replayed. In some examples, the counter that is incremented on the card is different from the counter that is incremented for transactions. The contactless card 400 is unable to determine the application transaction counter(s) 510 since there is no communication between applet(s) 508 on the contactless card 400.

In some examples, the counter(s) 510 may get out of sync. In some examples, to account for accidental reads that initiate transactions, such as reading at an angle, the counter(s) 510 may increment but the application does not process the counter(s) 510. In some examples, when the mobile device 10 is woken up, NFC may be enabled and the device 110 may be configured to read available tags, but no action is taken responsive to the reads.

To keep the counter(s) 510 in sync, an application, such as a background application, may be executed that would be configured to detect when a mobile device or other computing device wakes up and synchronize with the server of a banking system indicating that a read that occurred due to detection to then move the counter 104 forward. In other examples, hashed One Time Password may be utilized such that a window of mis-synchronization may be accepted. For example, if within a threshold of 10, the counter(s) 510 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 510 increases in the appropriate sequence, then it possible to know that the user has done so.

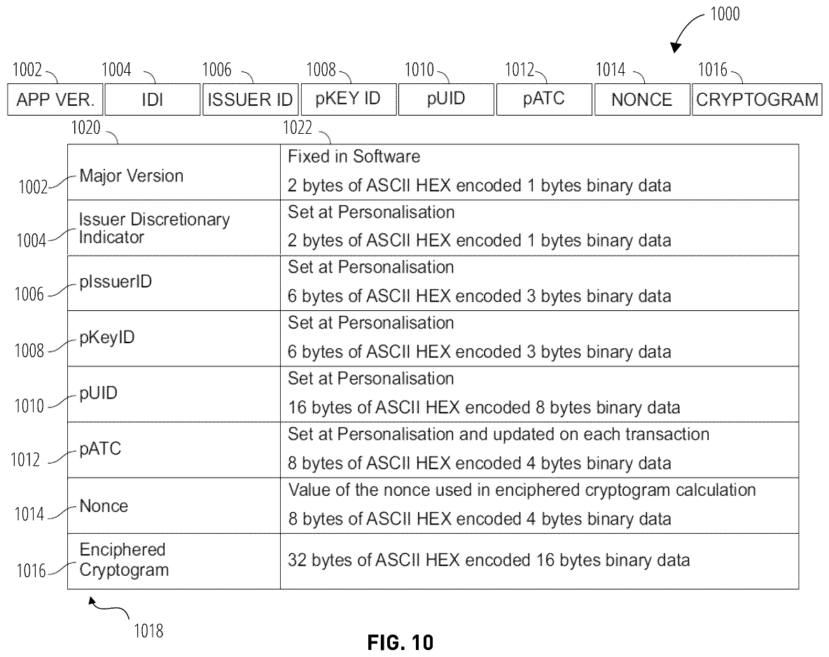

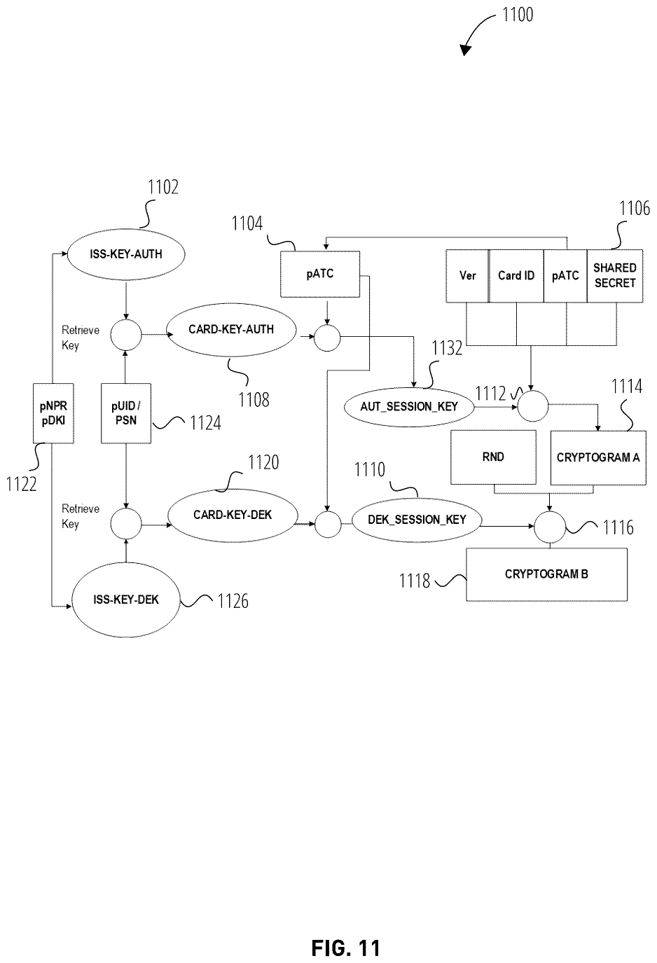

The key diversification technique described herein with reference to the counter(s) 510, master key, and diversified key, is one example of encryption and/or decryption a key diversification technique. This example key diversification technique should not be considered limiting of the disclosure, as the disclosure is equally applicable to other types of key diversification techniques. FIG. 10 illustrates one example of a message 1000, such as a cryptogram or encrypted data that may be generated based on key decryption. FIG. 10 and the corresponding text describe one example of generating keys, key diversification, and encryption/decryption. FIG. 11 illustrates a second example of key diversification techniques.

In some instances, during creation of the contactless card 400 two cryptographic keys may be assigned uniquely per card, card master keys. The cryptographic keys may comprise symmetric keys which may be used in both encryption and decryption of data. Triple DES (3DES) algorithm may be used by EMV and it is implemented by hardware in the contactless card 400. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 400 is used in operation, a different key may be used for creating the message authentication code (MAC) and for performing the encryption. This results in a triple layer of cryptography. The session keys may be generated by one or more applets and derived by using the application transaction counter with one or more algorithms.

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format. The authentication message from the contactless card 400 is representative of the encrypted data described above in FIG. 2 and FIG. 3, sent from the contactless card 102 to the user device 104. The authentication message or encrypted data can be delivered to, for example, the user device 104 of FIG. 1 or FIG. 2, and the user device 104 can send the authentication message, along with the session ID to the authentication server 110 for decrypting.

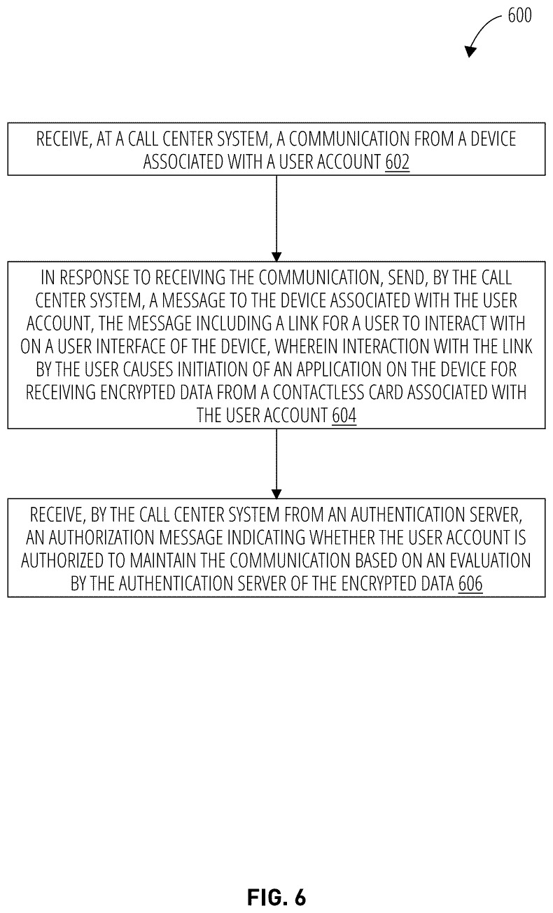

FIG. 6 is a flow chart illustrating operations in an example method 600 according to some embodiments of the present disclosure. As shown at block 602, in some embodiments, the method 600 includes receiving, at a call center system (e.g., a call server or other computing system), a communication from a device associated with a user account. As shown at block 604, the method 600 includes, in response to receiving the communication, sending, by the call center system, a message to the device associated with the user account, the message including a link for a user to interact with on a user interface of the device, wherein interaction with the link by the user causes initiation of an application on the device for receiving encrypted data from a contactless card associated with the user account. As shown at block 606, the method 600 further includes receiving, by the call center system from an authentication server, an authorization message indicating whether the user account is authorized to maintain the communication based on an evaluation by the authentication server of the encrypted data.

In some embodiments of the method 600, sending the message to the device includes the call center system assigning a session identifier (session ID) to the communication from the device; and including the session ID in the message to the device to associate the link in the message with the communication. In some embodiments of the method 600, receiving the authorization message from the authentication server includes receiving the session ID with the authorization message to associate the authorization message with the communication from the device.

In some other embodiments of the method 600, the communication from the device is among a plurality of communications received at the call center system, and the method 600 further includes the call center system assigning a corresponding unique session ID to each of the plurality of communications. In some embodiments, the method 600 further includes receiving a corresponding authorization message for at least some of the plurality of communications; and determining which of the plurality of communications are authorized based on each session ID included in the corresponding authorization messages received.

In some embodiments, the message is transmitted to a phone number or email address associated with the user, the phone number or email address being from an account database entry associated with the user; and the email address or phone number is associated with the device associated with the user.

In some embodiments, in response to the call center system receiving the authorization message that indicates that the user account is permitted to maintain the communication, the method 600 further includes maintaining, by the call center system, the communication with the device associated with the user account; and in response to the call center system receiving the authorization message that indicates that the user account is not permitted to maintain the communication, the method 600 further includes terminating, by the call center system, the communication with the device.

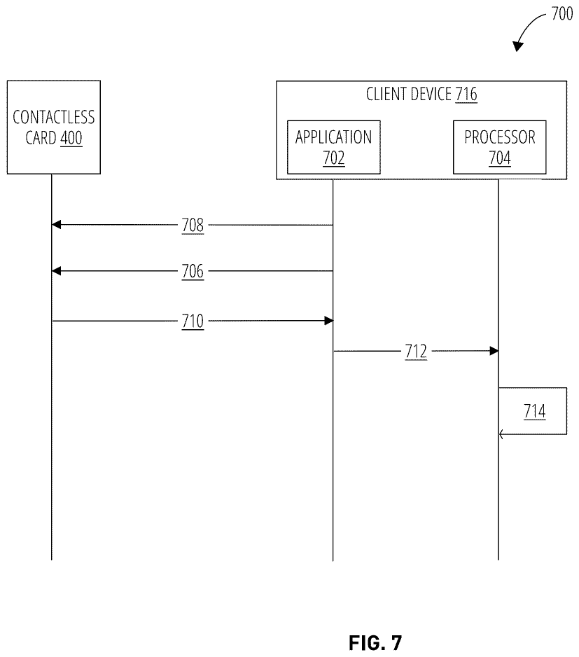

FIG. 7 is a timing diagram illustrating an example sequence for providing authenticated access according to one or more embodiments of the present disclosure. Sequence flow 700 may include contactless card 400 and client device 716, which may include an application 702 and processor 704. The client device 716 is representative of the user device 104 of FIG. 1, FIG. 2, and FIG. 3 above.

At line 708, the application 702 communicates with the contactless card 400 (e.g., after being brought near the contactless card 400 and within communication range). Communication between the application 702 and the contactless card 400 may involve the contactless card 400 being sufficiently close to a card reader (not shown) of the client device 716 to enable NFC data transfer between the application 702 and the contactless card 400.

At line 706, after communication has been established between client device 716 and contactless card 400, contactless card 400 generates a message authentication code (MAC) cryptogram or encrypted data. In some examples, this may occur when the contactless card 400 is read by the application 702. In particular, this may occur upon a read, such as an NFC read, of a near field data exchange (NDEF) tag, which may be created in accordance with the NFC Data Exchange Format. For example, a reader application, such as application 702, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 400 may be updated or incremented, which may be followed by “Read NDEF file.” At this point, the message may be generated, including a header and a shared secret. Session keys may then be generated. The MAC cryptogram or encrypted data may be created from the message, as discussed herein, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 702 may be configured to transmit a request to contactless card 400, the request comprising an instruction to generate a MAC cryptogram.

At line 710, the contactless card 400 sends the MAC cryptogram to the application 702. In some examples, the transmission of the MAC cryptogram occurs via NFC, however, the present disclosure is not limited thereto. In other examples, this communication may occur via Bluetooth, Wi-Fi, or other means of wireless data communication. At line 712, the application 702 communicates the MAC cryptogram to the processor 704.

At line 714, the processor 704 verifies the MAC cryptogram pursuant to an instruction from the application 122. For example, the MAC cryptogram or encrypted data may be verified, as explained herein. In some examples, verifying the MAC cryptogram may be performed by a device other than client device 716, such as a server of a banking system or authentication service of a switchboard system, in data communication with the client device 716. For example, processor 704 may output the MAC cryptogram for transmission to the banking system server, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

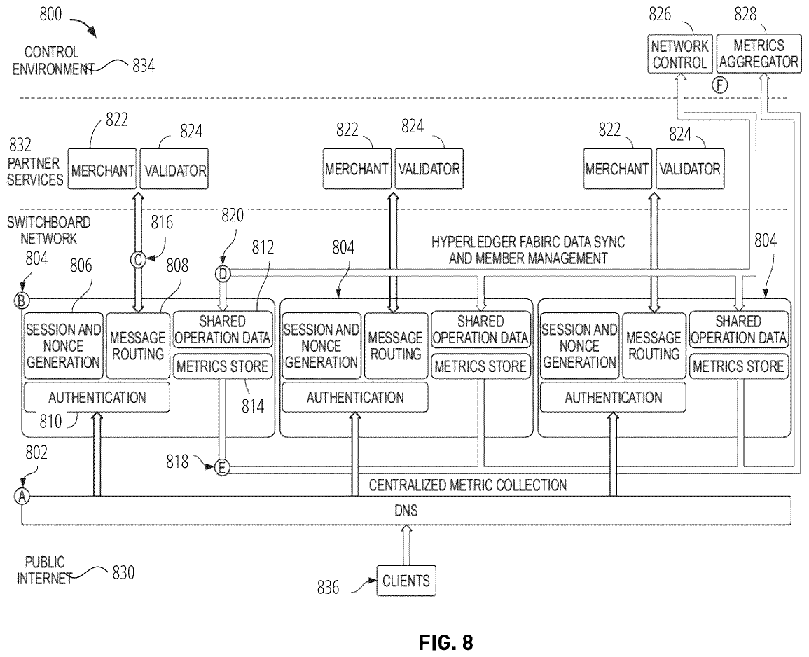

In some instances, embodiments may be implemented in a multi-issuer environment and messages, including the message from the user device 104 to the authentication server 110 containing the encrypted data from the contactless card 102 and the session ID, are routed through a switchboard system, such as routing system 800. FIG. 8 illustrates an example routing system 800 in accordance with the embodiments discussed herein. The routing system 800 includes additional devices and systems configured to enable contactless card issuers to tap-to-card services. More specifically, routing system 800 enables any number of issuer systems to provide card services to their clients through a switching fabric, i.e., the switchboard system in a secure and safe manner. The routing system 800 may be referred to herein as a switchboard system or a routing system 800.

To provide more context, in some embodiments, the routing system 800 provides routing for the encrypted data from the user device 104 (e.g., after it has been received by the user device 104) to the authentication server 110, as described above. The routing system 800 also describes how routing the authentication decision (e.g., after the authentication server 110 from FIG. 1 has decrypted the encrypted data and verified the identity of the user account based on the encrypted data) from the authentication server 110 to the call center system 108 or call server 300 is performed.

In embodiments, the switchboard routing system 800 includes one or more nodes 804 configured to perform routing operations. Each switchboard node 804 may include a session and nonce generator 806, a message router 808, an authentication 810, an operation data 812 store, and a metrics store 814. Further, each of the nodes may be configured the same and share configurations, but each switchboard node 804 may independently process and route messages and requests to the appropriate systems, such as the merchant systems and issuer systems. Each of the nodes 804 is configured to act as a broker of trust between an issuer system, the merchant system 822, and/or validation system 824, for example. Each switchboard node 804 is configured to route each message to the correct issuer system while maintaining data security. For example, a switchboard node 804 may route a message between an issuer system and a merchant system while the node cannot access the private data in the message. The merchant system 822 can, for example, be the call center system 108 or call server 300 from FIG. 1 or FIG. 3, respectively.

The switchboard routing system 800 may be configured as a server system with a collection of hardware, software, and networking components that work together to provide client services. Hardware components may include one or more server computers, storage devices, and network adapters. The server computers are configured to run server applications, such as those executable on each of the nodes 804. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 804 may operate in a cloud-based computing environment, e.g., a collection of hardware, software, and networking components that enable the delivery of cloud computing services. The switchboard nodes 804 and the computing services are delivered over the Internet and can be accessed from anywhere in the world with an Internet connection. In embodiments, client 836 may access a switchboard node 804 through DNS 802 (DNS). The DNS 802 is a hierarchical and distributed naming system for computers, services, and other resources connected to the Internet or other networks. It associates various information with domain names assigned to each registered participant. In one example, the DNS 802 may translate a name known to software executing on a client 836 to route data to one or more of switchboard node 804 of the switchboard system. In embodiments, the DNS 802 may generate a number, such as an Internet Protocol (IP) address, an address record (A-record), or another Hostname (C-name record). At a high level, the DNS 802 translates known domain names to numerical Internet Protocol (IP) addresses needed for locating and identifying computer services and devices with the underlying network protocols. Clients use the global DNS system to select the best node to use.

In one example, for a client to utilize DNS to resolve and communicate with one or more nodes of a switchboard system, such as the client 836, the DNS 802, and the switchboard node 804. Client 836 sends a request to a default DNS server for a text record switchboard. {domain}. {tld}. The text record may be preconfigured in a client app and/or client SDK. The DNS 802 returns one or more records. A DNS record structure may include the following:
Root Record:
   Name: switchboard. {domain}. {tld}
   Type: TXT
   Resolution:
      {nodename_1}. {operator_a}. {region_i}.switchboard. {domain}. {tld},
      {nodename_2}. {operator_a}. {region_i}.switchboard. {domain}. {tld},
      {nodename_1}. {operator_b}. {region_ii}.switchboard. {domain}. {tld},
      {nodename_2}. {operator_b}. {region_ii}.switchboard. {domain}. {tld},
      * etc.
   Used For determining where there are active nodes
Node Record:
   Name: {nodename}. {operator}. {region}.switchboard. {domain}. {tld}
   Type: A/AAAA or CNAME
   Resolution: Actual node hostname or IP
   Used For: communicating with a node 804

In embodiments, the client 836 may determine the current timezone. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. Further, the client 836 is configured to map the timezone to a region or short-version identifier of the region. One example includes America/New_York->na-e. The region may be based on DNS names, for example. Table 1 below illustrates a few examples of time zone mappings to regions:

TABLE 1

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples; other timezone-to-region mappings may be utilized. Further and in embodiments, regions can also be represented as a bidirectional graph structure with the edges representing geographic neighbors. For example, na-e<->na-w and sa <->na-w and sa<->na-e. This representation is useful for node selection.

Further, the client 836 may identify or select a DNS record option previously returned that is in the region. If there are multiple matches, the client may select one at random. If there's no node available in a region, the client 836 may determine and use a data graph of neighboring regions to select a node in the closest region where a node is available. For example, sa has no node but is connected to na-e where there is a node and so na-e is selected.

Embodiments include the client 836 resolving a selected node's hostname. In embodiments, the client 836 automatically resolves the hostname using the client's HTTP request default resolver. Further, the DNS 802 may return a result, and the client 836 may communicate with a switchboard node 804 and begin interacting with the switchboard.

In embodiments, a client 836 communicates with the switchboard system to perform one or more of the partner services 832, such as conducting a transaction with a merchant, validating the customer, or other tap-to functions. Once client 836 identifies a switchboard node 804 and resolves an address to communicate with switchboard node 804, client 836 may send one or more messages to switchboard node 804 to authenticate and perform the operation. The switchboard node 804 includes an authentication 810 function (e.g., the authentication server 110 of FIG. 1) configured to authenticate the client 836. In embodiments, the client 836 sends a message or authorization request to the switchboard node 804 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 2 below describes the value, name, and meaning:

TABLE 2

| Value | Name | Meaning |
|---|---|---|
| 65535 | Client ID | Individual |
| | | identifier |
| | | of client |
| GReyx5BuEAaE72bWbFZJfHRL8Dbt1Uum | Client Key | Randomly |
| | | assigned key |

The switchboard node 804 may authorize or authenticate the client 836 or user, and the switchboard node 804 may utilize the additional components, such as the session and nonce generator 806 and message router 808, to perform the operations. Note the validation systems validation systems 824 never interact with the merchant systems 822, nor vice versa. The nodes 804 brokers all communication.

In embodiments, the switchboard system may utilize a hyperledger fabric 820 to manage to synchronize the shared operation data 812 and member management across the network. The hyperledger fabric 820 is distributed ledger framework having a permissioned network model that only authorized participants can join the network and access the data that is stored on a ledger.

In embodiments, the hyperledger fabric 820 may be generated by creating one or more sets of peers, an ordering service, and a channel. Once the network is created, routing system 800 deploys chaincode to the network, or node 804 is permitted to access the fabric. The chaincode is the code that runs on the blockchain and executes the network control 826 and operation data 812 logic code. Once the chaincode is deployed, each of the switchboard nodes 804 is configured to invoke transactions on the blockchain to add data to the blockchain, e.g., the operational data. A switchboard node 804 or another device can query the ledger to retrieve data. The ledger is a distributed database that stores all the data added to the blockchain.

All nodes 804 keep an independently verifiable log of their actions that can be transmitted to a centralized aggregator to build a picture of overall network usage. Routing system 800 can manage network operation data and management at a central level and have a centralized view of network use, aggregated and abstracted to the appropriate level.

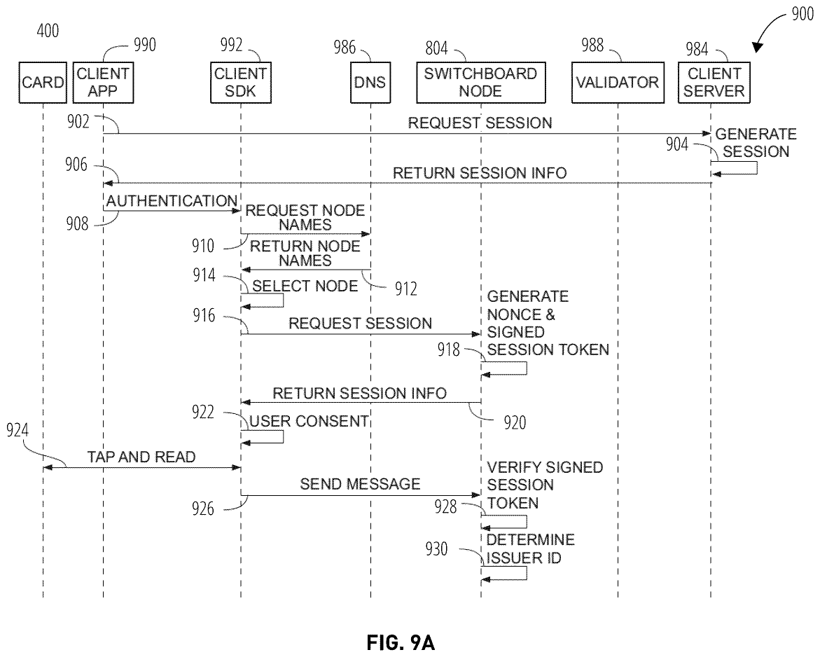

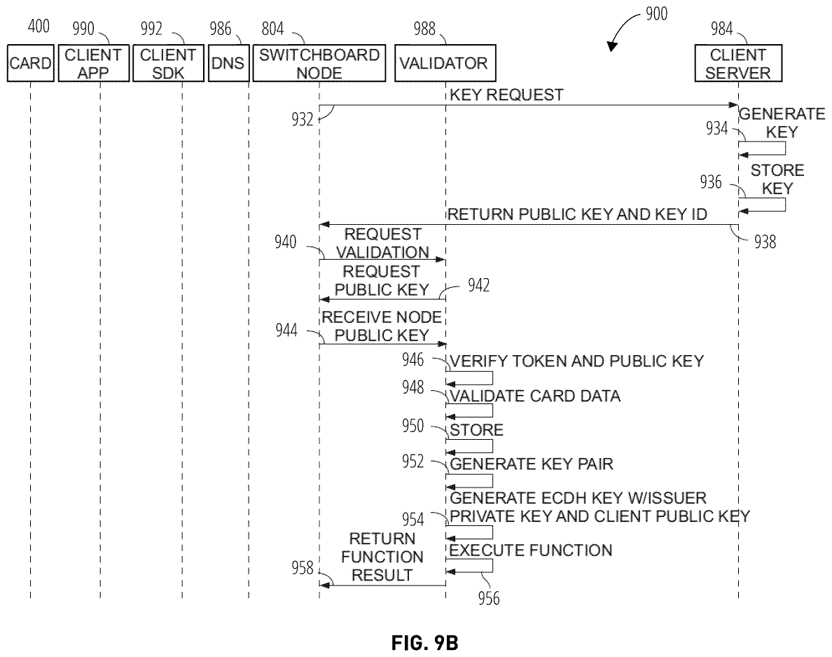

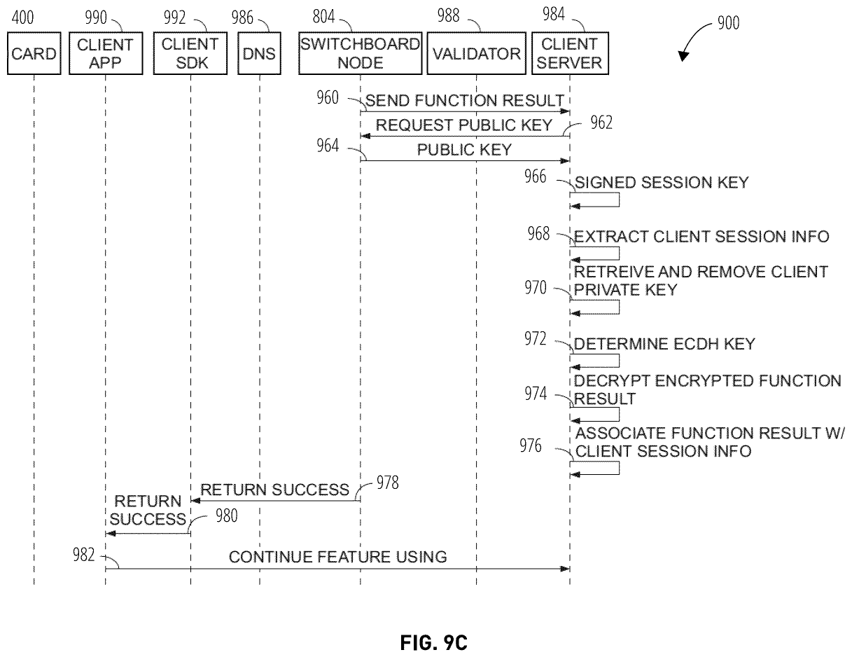

FIG. 9A-FIG. 9C illustrate an example sequence 900 to perform operations between a contactless card and services provided by a card issuer and/or call center system 108. The illustrated sequence 900 includes actions and communications performed by a contactless card 400, a client 836 including a client app 990 and a client SDK 992, a DNS 986, a switchboard system including one or more nodes 804, a partner services 832 including a call center system and/or validator 988, and control services 834 including a client server 984 or system. In embodiments, the client app 990 may be any application configured to execute on a client 836, such as a banking app, a call center app, a social media app, a travel app, a gaming app, a productivity app, an entertainment app, and so forth. In embodiments, the client app 990 includes a web browser to provide websites and pages. The client app 990 may include and/or utilize the client SDK 992, which may be a set of instructions that enable the client app 990 to communicate with other components of the switchboard system.

FIG. 9A illustrates that, in some embodiments, at 902 the client 836 including the client app may send a request and establish a session with a client server 984 such that a result may be associated with the correct client device or user. The request establishes a relationship between the client device and client server, which may be an issuer server. At 904, the client server 984 generates a session and CLIENT SESSION INFORMATION. At 906, the client server 984 returns the session information, e.g., the CLIENT SESSION INFORMATION. In embodiments, the CLIENT SESSION INFORMATION may be the client implementation-specific user session identification information.

At 908, the client app 990 may initiate a contactless card authentication process with the client app 990. For example, the client app 990 may call a function and/or pass information to the client app 990 to initiate authentication via a contactless card. At 910-914, the client SDK 992 may utilize DNS to identify a node and establish communication with the node. Specifically, at 910, the client 836 including the client SDK 992 may send a request for switchboard hostnames, and at 912 the the DNS 986 may return information including one or more hostnames. At 914, the client SDK 992 may determine a switchboard node to communicate. FIG. 8 illustrates an example of a more detailed sequence of the process to establish communication with a switchboard node 804.

At 916, the client SDK 992 may send a request for a session to the switchboard system 108. In embodiments, the request for a session may be for a function request in the format <FUNCTION REQUEST>. In embodiments, the FUNCTION REQUEST may be the data/function that the client would like to request once a contactless card has been validated. The function could be for any service discussed herein, e.g., authenticate the user, perform a transaction, request autofill data, etc. At 918, switchboard system node 804 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST>signed with <NODE PRIVATE KEY>, where the NODE PRIVATE KEY is the switchboard system node 804 private key. The switchboard system node 804 may include a NODE PUBLIC/PRIVATE KEY, which is a keypair used to sign and validate JWTs.

At 920, the switchboard system node 804 may return session information to the client client SDK 992. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 922, the client SDK 992 may determine and/or receive user consent to the terms of service. In one example, the client SDK 992 captures and records the user consent to <FUNCTION TOS> on <CONSENT DATE>with<TOS VERSION>. The CONSENT DATE may be the timestamp for the user's consent to the TOS.

At 924, the client client SDK 992 exchanges one or more messages with a contactless card. In one example, the exchange may be based on the contactless card being tapped to a client device. In embodiments, the client SDK 992 may provide data to the contactless card 400 to use during the session to perform the function. The data may be provided to the contactless card 400 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format:

TABLE 3

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . 0E | NONCE | 8 bytes of ASCII HEX encoded |
| | | 4 bytes binary data |
| 0F . . . 12 | Session Indicators | 4 bytes of ASCII HEX encoded |
| | | 2 bytes binary data |
| 13 . . . 16 | Control Indicators | 4 bytes of ASCII HEX encoded |
| | | 2 bytes binary data |
| 17 . . . 26 | Update Date | 16 bytes of ASCII HEX encoded |
| | creation Time | 8 bytes binary data - represents |
| | | 64 bit unix timestamp |
| 27 . . . 36 | Update MAC | MAC to protect control |
| | | indicators - 16 bytes of ASCII |
| | | HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK).

At 924, the contactless card may generate and provide a message to the client's device including the client SDK 992. The data in the message may be utilized by the system discussed herein to perform the function requested. One example of the message is illustrated and discussed in FIG. 10, message 1000.

At 926, the client including the client SDK 992 may send a message and information to the switchboard system node 804. The message may be the message received from the contactless card 400, e.g., message 1000. In addition, the client SDK 992 may send the consent date, the TOS version, and the signed session token to the switchboard system node 804. The switchboard system node 804 may utilize the information to ensure the session is valid. At 928, the switchboard system node 804 verifies the signed session token is valid, e.g., is the previously provided signed session token and includes the nonce previously generated and is in the message.

In some embodiments, the switchboard system node 804 is configured to determine which issuer system or client-server it should route the message to for processing. At 930, the switchboard system node 804 may determine the issuer ID by extracting it from the message received from the contactless card 400 via the client SDK 992. As mentioned, the issuer ID identifies the issuer of the contactless card 400.

As illustrated in FIG. 9B, in embodiments, the switchboard system node 804 is configured to generate and communicate secure communications with the issuer system, e.g., the client server 984 and the validator 988. At 932, the switchboard system node 804 sends a request for a key to the client server 984. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 934, the client server 984 generates a portion of the key. In some instances, the client server 984 may generate half of the ECDH key for encryption/decryption of PII. Specifically, the client server 984 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 936, the client-server 984 stores the generated portion of the key in storage. Specifically, the client server 984 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 984 may return the public key portion to the switchboard system node 804 with the KEY ID at 938. The switchboard system node 804 may store the public key portion with the KEY ID for later use, e.g., generation of the ECDH key. At 940, the switchboard system node 804 may request a validation to be performed by the validator 988. In one example, the switchboard system node 804 may send a request validation as Request validation <MESSAGE>, <SIGNED SESSION TOKEN>, <CLIENT EC PUBLIC KEY>, <CONSENT DATE>, and the <TOS VERSION>. The validator 988 may make an out-of-band request back to the switchboard system node 804 for the public key to verify the session at 942. At 944, the switchboard system node 804 may provide the node's public key, i.e., <NODE PUBLIC KEY>. Further at 946, the validator 988 may utilize the node's public key to verify the secure session token.

In embodiments, the validator 988 may validate the message at 948. In embodiments, the validator 988 may perform a number of validations including ensuring the nonce in the message is correct along with additional information, such as the card's unique identifier (pUID), and the counter value (pATC).

At 950, the validator 988 may store information associated with the session. For example, validator 988 may store the <CONSENT DATE> with the <TOS VERSION> and the <PUID>. The validator 988 may also generate another portion of the key, e.g., the ECDH key. For example, the 988 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 954, the validator 988 may generate the complete ECDH key. For example, the validator 988 generates the <ECDH KEY> from <ISSUER EC PRIVATE KEY> and <CLIENT EC PUBLIC KEY>. The ECDH KEY is the final key generated using ECDH key negotiation.

The validator 988 may utilize the ECDH KEY to encrypt data for the function. For example, if the validator 988 validates the message in some instances, the validator 988 may execute a function request to create a function result and encrypt the result with the ECDH KEY at 956. For example, the validator 988 may Execute <FUNCTION REQUEST> to create <FUNCTION RESULT> and encrypt it with the <ECDH KEY>. The function result may be any result based on the requested function, e.g., verification of the card.

At 958, the validator 988 may return the function result to the switchboard system node 804. In some instances, the function result is returned encrypted. For example, the validator 988 may return the <ENCRYPTED FUNCTION RESULT> and the <ISSUER EC PUBLIC KEY>.

As illustrated at FIG. 9C, in embodiments, the switchboard system node 804 sends the function result to the client server 984 to process the result. In one example, the switchboard system node 804 may send the <ENCRYPTED FUNCTION RESULT>, <KEY ID>, <ISSUER EC PUBLIC KEY>, and <SIGNED SESSION TOKEN>. At 962 and 964, the client server 984 may make a request for and receive the public key from the switchboard system node 804. In some instances, the exchange may be performed via out-of-band communication channels. The public key for the node may be <NODE PUBLIC KEY>. The public key may be used to verify the sender of the function result, etc. At 966, the client server 984 may verify the signed session key with the node's public key <NODE PUBLIC KEY> to verify the sender of the information. At 968, the client server 984 may extract client information from the signed session token. For example, the client server 984 may Extract <CLIENT SESSION INFO> from <SIGNED SESSION TOKEN>, i.e., extracting the client implementation-specific user session identification information.

Further, at 970, the client server 984 may retrieve the client's private key with the KEY ID. Specifically, the client server 984 may get and remove the <CLIENT PRIVATE KEY> from cache using the <KEY ID>. At 972, the client server 984 may generate or compute the ECDH key. For example, the client server 984 may compute the <ECDH KEY> with the <CLIENT PRIVATE KEY>+<ISSUER EC PUBLIC KEY>. The client server 984 may decrypt the function result with the computed key at 974. Specifically, the client server 984 may decrypt the <ENCRYPTED FUNCTION RESULT> with the <ECDH KEY> to determine the <FUNCTION RESULT>. At 976, the client server 984 associates the function result with the session.

In embodiments, the switchboard system node 804 may return whether the function result was successfully completed or not at 978 to the client SDK 992. Further at 980, the client SDK 992 may notify the client app 990 of the result. At 982, the client app 990 may utilize the feature. For example, the client app 990 may communicate with the client server 984 to continue the feature using the <CLIENT SESSION INFO> to fetch the redacted <FUNCTION RESULT>.

FIG. 10 illustrates an example of a message 1000 that may be communicated by a contactless card, such as contactless card 102 and contactless card 400 to perform the functions described herein, such as those discussed in FIG. 9A through FIG. 9C. In some embodiments, the message 1000 can include the encrypted data sent from the contactless card 102 to the user device 104 for authorizing the user account associated with the user device 104 for granting call center system resources. One or more of the fields in message 1000 may also be utilized to route the message 1000 through the switchboard system or routing system 800 from FIG. 8 and perform authentication/validation techniques.

In embodiments, the message 1000 includes an applet version 1002 field, an issuer discretionary indicator 1004 field, an Issuer Identifier 1006 field, a pKey ID 1008 field, a pUID 1010 field, a pATC 1012 field, a nonce 1014 field, and an encrypted cryptogram 1016.

In embodiments, the fields may be in plain text or encrypted. For example, the applet version 1002 field may include an applet version in plain text. The applet version indicates which applet version is installed on a contactless card and may be used by the other systems to determine how to process the message 1000 when communicated. For example, different Applet versions require different validation logic, e.g., an older message may be routed through the issuer system to perform various operations for validation, while a newer message may be routed through the switchboard system to perform the various operations, including validation.

In embodiments, the message 1000 includes an issuer discretionary indicator 1004 field that may include issuer data and set at the time of personalization. In addition, the message 1000 includes an Issuer Identifier 1006 field that may include a unique ID assigned to the entity issuing the card, e.g., the issuer. For example, when joining the system, each issuer may be assigned a unique identifier during an onboarding operation. The issuer ID can be used by the switchboard routing system 800 to route a message and its contents to the appropriate services that are associated with that particular issuer.

In embodiments, the message 1000 includes a pKey ID 1008 field. In some instances, the pKey ID 1008 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 400 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described below.

The message 1000 may include a pUID 1010 field, including a card unique identifier assigned to the contactless card 400 at personalization time. The pUID 1010 field data may be a combination of alphanumeric characters used to identify each card and associated with a user uniquely.

In embodiments, the message 1000 includes a pATC 1012 field configured to hold a counter value. The counter value keeps a count of reads (taps) made on the contactless card 400 in a hexadecimal format in one example. Further, a counter value may generate session keys to encrypt at least a portion of a message.

In embodiments, each time a message 1000 is created, a new session key is derived and utilized to generate one or more portions of the message 1000. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1000 is static and set on the card during personalization, and other data is dynamic and may be generated by the card during an operation, e.g., when a read operation is being performed. Note that in some instances, the static information may be updateable, but it may require the customer and card to go through a secure update process, which may be controlled by the issuer.

In embodiments, the contactless card 400 may communicate a message between a device, such as a mobile device, during a read operation. For example, in response to the contactless card 400 being tapped onto a surface of the device, e.g., brought within wireless communication range, a read operation may be performed on the contactless card 400, and the contactless card 400 may generate and provide the message to the device. For example, once within range, the contactless card 400 and the device may perform one or more exchanges for the contactless card 400 to send the message to the device.

The wireless communication may be in accordance with a wireless protocol, such as near-field communication (NFC), Bluetooth®, WiFi, and the like. In some instances, a message may be communicated between a contactless card 400 and a device via wired means, e.g., via the contact pad, and in accordance with the EMV protocol.

As discussed above, the contactless card 400 may be deployed with a unique card key, e.g., the UDK, that is generated from an issuer's master key and is used to generate session keys. The following discusses the generation of the UDK and the session keys (ASK) and (DESK). Further, the contactless card 400 may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 400. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card 400 may have one or more UDKs.

In embodiments, each contactless card 400 includes one or more applications, such as an authentication application, that is given a unique 16-digit identity (pUID) at time of personalization. Each contactless card 400 may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 400 stores the generated application key(s) or UDK(s).

In embodiments, the contactless card 400 utilizes the application key(s) or UDK(s) to generate session keys for each encrypted data is generated. The following is one processing flow that may be performed by the contactless to generate a unique cryptogram session key (ASK).

To generate the ASK, the contactless card 400 computes SKL by encrypting [ATC [2] ∥ ATC [3] ∥ ‘F0’ ∥ ‘00’ ∥ [ATC [0] ∥ [ATC [1] ∥ [ATC [2] ∥ [ATC [3]] with an application key. Further, the contactless card 400 computes SKR by encrypting [ATC [2] ∥ ATC [3] ∥ ‘0F’ ∥ ‘00’ ∥ [ATC [0] ∥ [ATC [1] ∥ [ATC [2] ∥ [ATC [3] with the application key. Finally, the contactless card 400 concatenates SKL with SKR to form an authentication session key (ASK). In embodiments, the ASK is used to perform operations utilizing the contactless card 400, such as encrypting the cryptographic MAC.

In embodiments, the contactless card 400 also supports session key derivation to generate a unique encipherment session key DESK. The contactless card 400 computes an SKL by encrypting [ATC [2] ∥ ATC [3] ∥ ‘F0’ ∥ ‘00’ ∥ ‘00’ ∥ ‘00’ ∥ ‘00’ ∥ ‘00’] with a Data Encryption Key (DEK) or UDK. Further, the contactless card 400 computes SKR by encrypting [ATC [2] ∥ ATC [3] ∥ ‘0F’ ∥ ‘00’ ∥ ‘00∥ ‘00’ ∥ ‘00’ ∥ ‘00’] with the DEK or UDK. The contactless card 400 concatenates SKL with SKR to form the Data Encipherment Session Key (DESK).

In embodiments, the contactless card 400 generates encrypted data or a cryptogram utilizing the session keys. Specifically, the contactless card 400 generates a cryptogram C by calculating a MAC over the 32-byte transaction data T using the Authentication Session Key (ASK).

The contactless card 400 may process the data to generate the cryptogram. Specifically, the contactless card 400 divides T into four blocks of 8 bytes of data: T=T1∥ T2∥ T3∥ T4. The contactless card 400 computes B=DES (ASKL) [T1], where is the Data Encryption Standard or another symmetric encryption algorithm, ASKL is a portion of the ASK, e.g., the “left” half of the key. The contactless card 400 computes B=[B XOR T2], and, the contactless card 400 computes B=DES (ASKL) [B], where DES is an encryption algorithm. The contactless card 400 computes B=[B XOR T3], and the contactless card 400 computes B=DES (ASKL) [B]. The contactless card 400 computes B=[B XOR T4], and the contactless card 400 computes B=DES (ASKL) [B]. The contactless card 400 computes B=DES-1 (ASKR) [B], where DES-1 is the reciprocal DES operation, and ASKR is a portion of the ASK, e.g., the right half. The contactless card 400 computes the cryptogram C=DES (ASKL) [B].

In embodiments, a contactless card 400 may also encipher the cryptogram to secure the data further. For example, a contactless card 400 may generate an 8-byte random number [RND] and the card computes E1=DES3 (DESK) [RND], where DES3 is a symmetric encryption algorithm such as the Triple Data Encryption Standard. The contactless card 400 then computes B=[E1] XOR [C], where C is the cryptogram generated, as discussed above. The contactless card 400 computes E2=DES3 (DESK) [B], where B is computed above. Further, the contactless card 400 generates the 16-byte enciphered payload E=[E1] ∥ [E2].

In embodiments, a device or the contactless card 400 may decrypt the payload E by determining, receiving, or retrieving the payload E. The device computes a RND=DES3−¹ (DESK) [E1]. The device determines B=DES3-1 (DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 400 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥ Update Date Time (8 bytes)∥ ‘80’ ∥ ‘00 00 00 00 00’]. For the calculations, the data may be divided into two separate portions. Specifically, the data U is broken into two blocks of 8 bytes of data, where U=U₁ ∥ U₂. Further, operations may be performed on U₁ and U₂.

Embodiments include applying an algorithm to the first portion (U₁) of the data. In one example, a result B may be computed where B=DES (MCKL) [U1], where DES is a Data Encryption Standard algorithm using a first portion (L) of the MAC Card Key (MCKL).

Further, an additional operation may be performed on the result B. Specifically, the result B may be exclusively or′d (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

FIG. 11 illustrates a diagram of a system 1100 configured to implement one or more embodiments of the present disclosure. More specifically, the cryptogram 1118 generated herein is one example embodiment of the encrypted data sent by the contactless card 102 to the user device 104 in FIG. 1. The following description of FIG. 11 details one example of how the authentication code of the encrypted data can be created by the contactless card 400. As explained below, during the contactless card 400 creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card 400. By using a key diversification process, one or more keys may be derived from a master key based upon uniquely identifiable information for each entity that requires a key.

Regarding master key management, two issuer master keys 1102, 1126 may be required for each part of the portfolio on which the one or more applets is issued. For example, the first master key 1102 may comprise an Issuer Cryptogram Generation/Authentication Key (Iss-Key-Auth) and the second master key 1126 may comprise an Issuer Data Encryption Key (Iss-Key-DEK). As further explained herein, two issuer master keys 1102, 1126 are diversified into card master keys 1108, 1120, which are unique for each card. In some examples, a network profile record ID (pNPR) 1122 and derivation key index (pDKI) 1124, as back office data, may be used to identify which Issuer Master Keys 1102, 1126 to use in the cryptographic processes for authentication. The system performing the authentication may be configured to retrieve values of pNPR 1122 and pDKI 1124 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1108 and Card-Key-Dek 1120). The session keys (Aut-Session-Key 1132 and DEK-Session-Key 1110) may be generated by the one or more applets and derived by using the application transaction counter (pATC) 1104 with one or more algorithms. To fit data into the one or more algorithms, only the 2 low order bytes of the 4-byte pATC 1104 is used. In some examples, the four byte session key derivation method may comprise: F1: =PATC (lower 2 bytes)∥ ‘F0’ ∥ ‘00’ ∥ PATC (four bytes) F1: =PATC (lower 2 bytes)∥ ‘0F’ ∥ ‘00’ ∥ PATC (four bytes) SK: ={(ALG (MK) [F1])∥ ALG (MK) [F2]}, where ALG may include 3DES ECB and MK may include the card unique derived master key.

As described herein, one or more MAC session keys may be derived using the lower two bytes of pATC 1104 counter. At each tap of the contactless card, pATC 1104 is configured to be updated, and the card master keys Card-Key-AUTH 508 and Card-Key-DEK 1120 are further diversified into the session keys Aut-Session-Key 1132 and DEK-Session-KEY 1110. pATC 1104 may be initialized to zero at personalization or applet initialization time. In some examples, the pATC counter 1104 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1132. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1132, as explained above. As explained above, the low order two bytes of the counter may be used to diversify for the one or more MAC session keys. As explained below, AUT-Session-Key 1132 may be used to MAC data 1106, and the resulting data or cryptogram An 1114 and random number RND may be encrypted using DEK-Session-Key 1110 to create cryptogram B or output 1118 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1110 derived from the Card-Key-DEK 1120. In this case, the ATC value for the session key derivation is the least significant byte of the counter pATC 1104.

The format below represents a binary version example embodiment. Further, in some examples, the first byte may be set to ASCII ‘A’.

| Message Format | | | | | | |
|---|---|---|---|---|---|---|
| 1 | 2 | 4 | | 8 | | 8 |
| 0x43 (Message | Version | pATC | | RND | | Cryptogram |
| Type ‘A’) | | | | | | A (MAC) |
| Cryptogram | 8 bytes | | | | | |
| A (MAC) | | | | | | |
| MAC of | | | | | | |
| 2 | 8 | 4 | 4 | | 18 bytes input data | |
| Version | pUID | pATC | Shared Secret | | | |
| Message Format | | | | | | |
| 1 | 2 | 4 | | 16 | | |
| 0x43 (Message | Version | pATC | | Cryptogram B | | |
| Type ‘A’) | | | | | | |
| Cryptogram | 8 bytes | | | | | |
| A (MAC) | | | | | | |
| MAC of | | | | | | |
| 2 | 8 | 4 | 4 | | 18 bytes input data | |
| Version | pUID | pATC | Shared Secret | | | |
| Cryptogram B | 16 | | | | | |
| Sym Encryption | | | | | | |
| of | | | | | | |
| 8 | 8 | | | | | |
| RND | Cryptogram | | | | | |
| | A | | | | | |

Another exemplary format is shown below. In this example, the tag may be encoded in hexadecimal format.

| Message Format | | | | |
|---|---|---|---|---|
| 2 | 8 | 4 | 8 | 8 |
| Version | pUID | pATC | RND | Cryptogram |
| | | | | A (MAC) |
| 8 bytes | | | | |

| 8 | 8 | 4 | 4 | 18 bytes input data |
|---|---|---|---|---|
| pUID | pUID | pATC | Shared Secret | |

| Message Format | | | | | |
|---|---|---|---|---|---|
| 2 | 8 | 4 | | 16 | |
| Version | pUID | pATC | | Cryptogram B | |
| 8 bytes | | | | | |
| 8 | | 4 | 4 | | 18 bytes input data |
| pUID | pUID | pATC | Shared Secret | | |
| Cryptogram B | 16 | | | | |
| Sym Encryption | | | | | |
| of | | | | | |
| 8 | 8 | | | | |
| RND | Cryptogram | | | | |
| | A | | | | |

The UID field of the received message may be extracted to derive, from master keys Iss-Key-AUTH 1102 and Iss-Key-DEK 1126, the card master keys (Card-Key-Auth 1108 and Card-Key-DEK 1120) for that particular card. Using the card master keys (Card-Key-Auth 1108 and Card-Key-DEK 1120), the counter (pATC) field of the received message may be used to derive the session keys (Aut-Session-Key 1132 and DEK-Session-Key 1110) for that particular card. Cryptogram B 1118 may be decrypted using the DEK-Session-KEY, which yields cryptogram An 1114 and RND, and RND may be discarded. The UID field may be used to look up the shared secret of the contactless card 400 which, along with the Ver, UID, and pATC fields of the message, may be processed through the cryptographic MAC using the re-created Aut-Session-Key to create a MAC output, such as MAC′. If MAC′ is the same as cryptogram An 1114, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1132. The input data 1106 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′00′ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1112, data 1106 is processed through the MAC using Aut-Session-Key 1132 to produce MAC output (cryptogram A) 1114, which is encrypted.

In order to provide additional protection against brute force attacks exposing the keys on the card, it is desirable that the MAC cryptogram 1114 be enciphered. In some examples, data or cryptogram a MAC cryptogram 1114 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1110. In the encryption operation 1116, data or cryptogram An 1114 and RND are processed using DEK-Session-Key 1110 to produce encrypted data, cryptogram B 1118. The data 1114 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

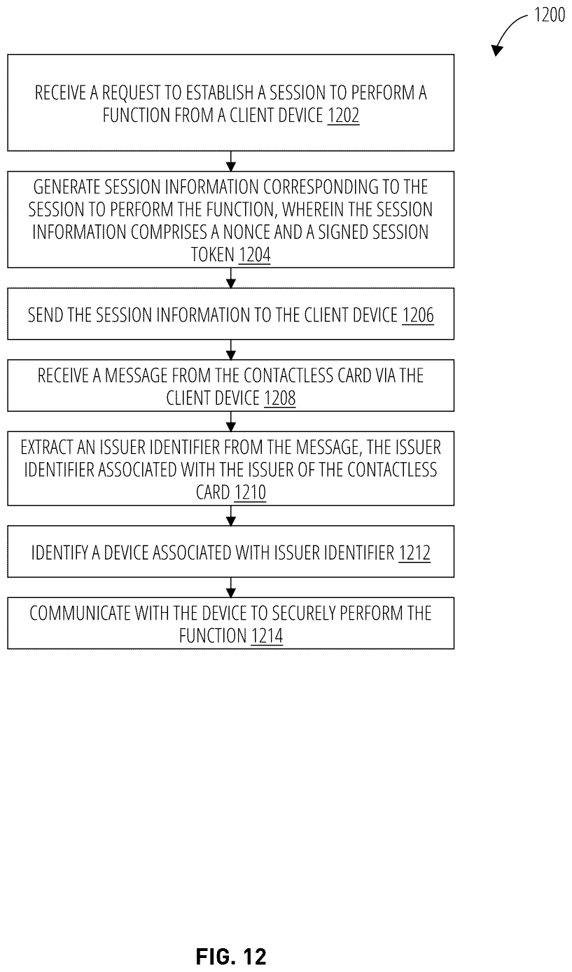

FIG. 12 illustrates an example of routine 1200 in accordance with embodiments discussed herein. In block 1202, the routine 1200 includes receiving, by a node in a system, a request to establish a session to perform a function from a client device, wherein the function is at least partially performed utilizing a contactless card 400. In some instances, the node may be one of a plurality nodes of a switchboard system. The node may be previously selected by the sending device via a DNS operation performed.

In block 1204, the routine 1200 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card 400 is authenticated, and to keep track of the session for the function.

In block 1206, routine 1200 includes sending the session information to the client device by the node. The client device may communicate with a contactless card 400 to receive data from the card to authenticate and perform a function. In some instances, the client device may send the nonce from the node to the contactless card 400. The contactless card 400 may utilize the nonce when generating the message to communicate back to the client device. Finally, the node, e.g., incorporates it into a cryptographic portion of the message (see FIG. 10).

In block 1208, routine 1200 includes receiving, by the node, a message from the contactless card 400 via the client device. The message may be generated by the contactless card 400. FIG. 10 illustrates one example of a message 1000. In some embodiments, the node verifies the message. For example, the node may verify a nonce in the message and a signed session token.

In block 1210, routine 1200 extracts an issuer identifier from the message by the node, the issuer identifier associated with the issuer of the contactless card 400. In some instances, the issuer identifier may be in a plaintext format.

In block 1212, routine 1200 identifies, by the node, a device associated with the issuer identifier. For example, the node may perform a lookup to determine a server associated with the issuer identifier and the function to be performed.

In block 1214, routine 1200 communicates, by the node, with the device to securely perform the function.

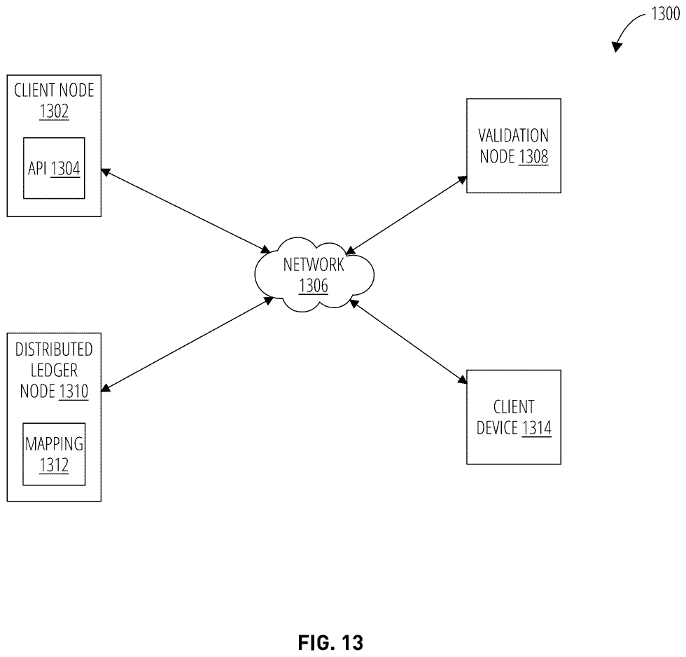

FIG. 13 illustrates a distributed network authentication system 1300 according to an example embodiment. The distributed network authentication system 1300 can act or operate as the authentication server 110 described herein. As further discussed below, system 1300 can include client node 1302, API 1304, network 1306, distributed ledger node 1310, mapping 1312, and client device 1314. Although FIG. 13 illustrates single instances of the components, system 1300 can include any number of components.

System 1300 can include a client node 1302, which can be a network-enabled computer as described herein. In some examples, client node 1302 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, client node 1302 can execute one or more applications, such as software applications, that enable, for example, network communications with one or more components of system 1300, transmit and/or receive data, and perform the functions and processes described herein.

The client node can contain an API 1304. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1304 to interact with the service, such as by performing a remote call to an API for interacting with a web-based service.

API 1304 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1302 can communicate with one or more other components of system 1300 either directly or via network 1306 (e.g., representative of network 106). Network 1306 can comprise one or more of a wireless network, a wired network or any combination of wireless network and wired network, and may be configured to connect the components of system 1300. While FIG. 13 illustrates communication between the components of system 1300 through network 1306, it is understood that any component of system 1300 can communicate directly with another component of system 1300, e.g., without involving network 1306.

System 1300 can include a validation node 1308, which can be a network-enabled computer as described herein. In some examples, validation node 1308 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, validation node 1308 can execute one or more applications, such as software applications, that enable, for example, network communications with one or more components of system 1300, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1300 can include a distributed ledger node 1310, which can be a network-enabled computer as described herein. In some examples, distributed ledger node 1310 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, distributed ledger node 1310 can execute one or more applications, such as software applications, that enable, for example, network communications with one or more components of system 1300, transmit and/or receive data, and perform the functions and processes described herein.

Distributed ledger node 1310 can containing a mapping 1312. In some examples, mapping 1312 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1300, or the one or more databases can be hosted externally to any component of the system 1300. In some examples, the one or more databases can be contained in the distributed ledger node 1310, and in other examples the one or more databases can be stored outside of distributed ledger node 1310 but in data communication with distributed ledger node 1310.

The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=′value′;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1310. In other examples, the one or more databases can be remote from distributed ledger node 1310 but in data communication with distributed ledger node 1310. Data communication between the one or more databases and distributed ledger node 1310 can be a direct data communication or data communication via a network, such as the network 1306.

In some examples, client node 1302 can be in data communication with distributed ledger node 1310. Distributed ledger node 1310 can contain mapping 1312. Mapping 1312 may include, e.g., a mapping between a validation node address and the validation node 1308, a mapping between a routing number and a validation node address, and/or a mapping between a routing number and validation node 1308. In some examples, mapping 1312 can include a digital signature associated with an entity having permission to validate for a routing number. Based on one or more of these associations, client node 1302 can call validation node for validation and/or provide direction to the client device to reach the appropriate validation node. This can be accomplished by calling a validation API associated with validation node 1308.

In some examples, iterations of the mappings described herein, such as mapping 1312, can also include a software or applet version number. The version number can be used to identify a validation node or validation node address or choose between multiple validation addresses for one validation node.

In some examples, client node 1302 and distributed ledger node 1310 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1310 can update mapping 1312 to reflect a different association between, e.g., a routing number, a validation node address, and a validation node. In some examples, degrees of permissions can be issued. For example, if client node 1302 were to function to route data to validation node 1308 (or other validation nodes), client node 1302 can be given a certain level of permissions. As another example, if distributed ledger node 1310 were to have the capability to update mapping 1312, distributed ledger node 1310 can have a different, higher level of permissions.

System 1300 can include a client device 1314, which can be a network-enabled computer as described herein. In some examples, distributed ledger node 1314 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300. Client device 1314 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1314 can be in data communication with another network-enabled computer not shown in FIG. 13, such as a smart card (e.g., a contactless card, such as contactless card 400, or a contact-based card).

In some examples, client device 1314 can execute one or more applications, such as software applications, that enable, for example, network communications with one or more components of system 1300, transmit and/or receive data, and perform the functions and processes described herein.

In some examples, upon receipt of an authentication request, client device 1314 can call (e.g., via an API) client node 1302. The call can include a routing number and/or an applet or software version number, and client node 1302 can query distributed ledger node 1310 and mapping 1312. Once the query returns the identification of a validation node (e.g., validation node 1308) and/or a validation node address associated with that routing number and/or applet or software version, client node 1302 can reply to client device 1314. Client device 1314 can then proceed with authentication with the validation node. The authentication can be performed by, e.g., the systems and methods described herein, such as by the generation, encryption, transmission, decryption, and validation of a cryptogram as described herein.

In some examples, client node 1302 can be co-resident with validation node 1308. In these examples, client node 1302 can handle the authentication in a single call from client device 1314. In some examples, this can be acceptable only if it is permissible for the full authentication transmission (e.g., a cryptogram as described herein) to be sent to client nodes that are not involved in authentication.

In some examples, if client node 1302 receives, from client device 1314, a routing number that is not handled by its location, client node 1302 can return a code indicating that this routing number is not handled, along with validation node address for the responsible validation node. Client device 1314 can then send the full authentication transmission to validation node 1308 using the received validation node address.

In some examples, client node 1302 can enter the distributed network with different permissions. For example, client node 1302 can be a read-only router of data. As another example, client node 1302 can have permission to send messages to distributed ledger node 1310 updating one or more routing paths for one or more routing numbers. However, client node 1302 would be prevented from updating one or more routing paths for one or more routing numbers for other entities that control other routing numbers which are not associated with client node 1302 or that did not grant this permission. As another example, distributed ledger node 1310 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1302, distributed ledger node 1310, and/or validation node 1308, if security, legal, and/or financial conditions are met, however, delegation is not required.

In some examples, one or more APIs can facilitate communication between components of system 1300 via network 1306. In other examples, one or more APIs are not required. Rather, the components of system 1300 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1308 for authentication, can require storage of the keys in one or more HSMs, to promote key security and ensure that the keys are never entered into memory.

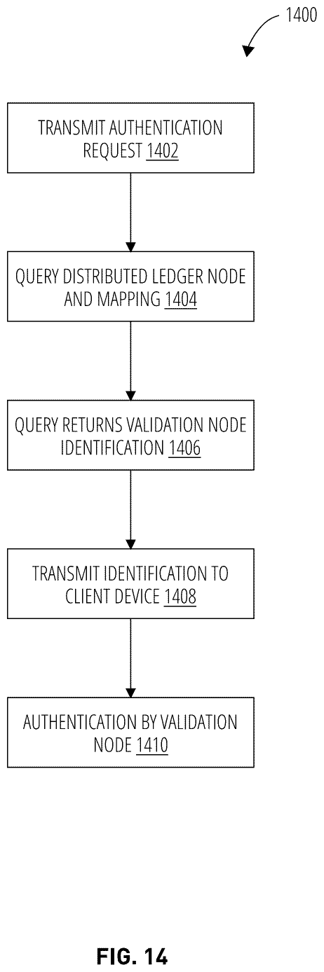

FIG. 14 illustrates a method 1400 performed by a distributed network authentication system according to an example embodiment. For example, the method can be performed by distributed network authentication system 1300 and or by another distributed network authentication system.

In block 1402, a client device can transmit an authentication request to a client node. The authentication request can include, without limitation, a routing number, a software version number, and/or an applet version number. The request can be made by an API call or other communication between the client device and the client node.

In block 1404, after receiving the authentication request, the client node can transmit a query (e.g., via an API call) to a distributed ledger node. The distributed ledger node contain a mapping, and the distributed ledger node can submit the query to the mapping.

In block 1406, the query can return an identification of a validation node and/or a validation node address, and the distributed ledger node can transmit this identification to the client node.

In block 1408, the client node can transmit the identification to the client device. After receiving the identification, the client device can proceed with authentication with the identified validation node and/or validation node address, in block 1410.

The various elements of the devices as previously described with reference to FIGS. 1-14 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
receiving, at a call center system, a communication from a device associated with a user account;
in response to receiving the communication, sending, by the call center system, a message to the device associated with the user account, the message including a link for a user to interact with on a user interface of the device, wherein interaction with the link by the user causes initiation of an application on the device for receiving encrypted data from a contactless card associated with the user account; and
receiving, by the call center system from an authentication server, an authorization message indicating whether the user account is authorized to maintain the communication based on an evaluation of the encrypted data by the authentication server.

2. The method according to claim 1, wherein sending the message to the device includes the call center system:
assigning a session identifier (session ID) to the communication from the device; and
including the session ID in the message to the device to associate the link in the message with the communication.

3. The method according to claim 2, wherein receiving the authorization message from the authentication server includes receiving the session ID with the authorization message to associate the authorization message with the communication from the device.

4. The method according to claim 2, wherein the communication from the device is among a plurality of communications received at the call center system, and wherein the method further comprises the call center system assigning a corresponding unique session ID to each of the plurality of communications.

5. The method according to claim 4, further comprising:
receiving a corresponding authorization message for at least some of the plurality of communications; and
determining which of the plurality of communications are authorized based on each session ID included in the corresponding authorization messages received.

6. The method according to claim 1, wherein the message is transmitted to a phone number or email address associated with the user account, the phone number or email address being from an account database entry associated with the user account; and
wherein the email address or phone number is associated with the device associated with the user account.

7. The method according to claim 1, further comprising:
in response to the call center system receiving the authorization message that indicates that the user account is permitted to maintain the communication, maintaining, by the call center system, the communication with the device associated with the user account; and
in response to the call center system receiving the authorization message that indicates that the user account is not permitted to maintain the communication, terminating, by the call center system, the communication with the device.

8. An apparatus comprising:
a memory to store instructions thereon;
a user interface to receive input and display output to a user of the apparatus; and
a processing circuit to execute the instructions, which when executed by the processing circuit, cause the apparatus to:
receive, from a call center system, a message including a link for the user of the apparatus to interact with via the user interface;
in response to the user interacting with the link, initiate operation of an application of the apparatus, the application to receive encrypted data from a contactless card associated with a user account of the user;
receive the encrypted data from the contactless card; and
send the encrypted data to an authentication server to verify an identity of the user account.

9. The apparatus according to claim 8, wherein the processing circuit is to receive the message in response to the apparatus initiating a communication with the call center system.

10. The apparatus according to claim 9, wherein the processing circuit is further to:
receive, as part of the message from the call center system, a session identifier (session ID) to associate the communication with the encrypted data; and
send the encrypted data with the session ID to the authentication server.

11. The apparatus according to claim 8, wherein the link is a universal resource locator (URL), quick response code (QR code), or a digital reference to a website or a software application, and interaction with the link includes the user interface to receive input from the user indicating selection of the link.

12. The apparatus according to claim 8, wherein the processor to initiate operation of an application of the apparatus includes the processor to further:
initiate operation of a web browser or a software application of the apparatus, the web browser directed to a website, or the software application opened, based on contents of the link.

13. The apparatus according to claim 12, wherein the processing circuit is further to:
initiate, by the website or the software application, a receive function of the apparatus, whereby the receive function causes the apparatus to receive, via a communication interface of the apparatus, the encrypted data from the contactless card when the contactless card is brought within a proximity of the apparatus.

14. A non-transitory computer-readable storage medium having instructions stored thereon, which when executed by a processing circuit of a voice server, causes the voice server to:
receive a communication from a device associated with a user account;
in response to receiving the communication, send a message to the device associated with the user account, the message including a digital reference for a user to interact with on a user interface of the device, wherein interaction with the digital reference by the user causes initiation of an application on the device for receiving encrypted data from a contactless card associated with the user account; and
receive, from an authentication server, an authorization message indicating whether the user account is authorized to maintain the communication based on an evaluation of the encrypted data by the authentication server.

15. The non-transitory computer-readable storage medium according to claim 14, wherein the voice server to send the message to the device includes the voice server to:
assign a session identifier (session ID) to the communication from the device; and
include the session ID in the message to the device to associate the digital reference in the message with the communication,
wherein the voice server to receive the authorization message from the authentication server includes the voice server to receive the session ID with the authorization message to associate the authorization message with the communication from the device.

16. The non-transitory computer-readable storage medium according to claim 15, wherein the communication from the device is among a plurality of communications received at the voice server, and wherein voice server is further to:
assign a corresponding unique session ID to each of the plurality of communications;
receive, from the authorization server, a corresponding authorization message for at least some of the plurality of communications; and
determine which of the plurality of communications are authorized based on each session ID included in the corresponding authorization messages received.

17. The non-transitory computer-readable storage medium according to claim 14, wherein the digital reference comprises a universal resource locator (URL) or a quick response code (QR code) to a website or a software application that, when interacted with or selected, causes the device to receive the encrypted data from a contactless card associated with the user account.

18. The non-transitory computer-readable storage medium according to claim 14, wherein the voice server includes or is in communication with an account database;
wherein the message is transmitted to a phone number or email address associated with the user account, the phone number or email address being from an account database entry in the account database.

19. The non-transitory computer-readable storage medium according to claim 14, wherein the voice server is further to:
in response to receiving the authorization message that indicates that the user account is permitted to maintain the communication, maintain the communication with the device associated with the user account; and
in response to receiving the authorization message that indicates that the user account is not permitted to maintain the communication, terminate the communication with the device.

20. The non-transitory computer-readable storage medium according to claim 14, wherein the voice server is further to:
store a record of the authorization message in memory for a predefined period of time; and
in response to the voice server receiving a subsequent communication from the device associated with the user account within the predefined period of time, bypass sending the message to the device and maintain the subsequent communication with the device associated with the user account based on the stored record of the authorization message.
